(19) United States
(12) Patent Application Publication
(10) Pub. No.: US 2008/0131852 A1
(43) Pub. Date: Jun. 5, 2008

(54) Systems and methods for teaching proper letter and character formation

(76) Inventor: Jenee Candee Van Hofwegen, Redwood City, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/565,242

(22) Filed: Nov. 30, 2006

(51) Int. Cl. G09B 11/04

(52) U.S. Cl. 434/165

(57) ABSTRACT

Color, lines, and arrows are used to teach the proper formation or writing of letters, numbers or other characters. For each part of a character requiring the lifting of the writing implement, a different color within a character outline is displayed. Color is also used to teach the proper sequencing of writing a character. Where directional changes may be confusing because of a lack of color change, arrows show directional changes within character segments. The instructional character set may be presented to students as a color reference guide, or may take other forms such as a coloring book, flash cards, or a computer program.

### CROSS-REFERENCE TO RELATED APPLICATIONS

Not Applicable

### STATEMENT REGARDING FEDERALLY SPONSORED RESEARCH OR DEVELOPMENT

Not Applicable

Reference to a Sequence Listing

Not Applicable

### BACKGROUND OF THE INVENTION

(1) Field of the Invention

The invention relates to means and methods of teaching the proper formation or writing of letters, numbers, or other characters. Color is used in drawing sheets, flash cards and computer programs to teach and display the correct sequencing of writing the various parts of a letter and where and when a writing implement should be lifted. Arrows and lines are used to show the proper starting points and direction of writing.

(2) Description of the Related Art

Several attempts to teach letter and/or character writing are known in the related art.

U.S. Pat. No. 3,638,332 by Jones teaches the use of different colored horizontal parallel lines to create a writing readiness paper. While the Jones invention may help in teaching the correct vertical height for upper and small case letters in general, Jones fails to teach the order of strokes or direction of writing needed to form letters or characters.

U.S. Pat. No. 4,016,660 by Ingalls discloses alphabet flash cards using ridges, texture, and roughness to allow a student to feel the shape of letters. Ingalls fails to teach where a writing implement is lifted off the paper when writing a letter or character.

U.S. Pat. No. 4,685,885 by Maddocks discloses a grooved wooden block where correct writing direction is taught through shingled surfacing in the grooves. Unfortunately, Maddocks does not allow a student to see her finished work product. Maddocks relies upon cumbersome and relatively expensive materials.

U.S. Pat. No. 5,114,346 by Fioramonti uses color to distinguish between the left-hand side and the right-hand side of three-dimensional letters. While Fioramonti may attempt to teach the proper orientation of letters, Fioramonti does not attempt to demonstrate the proper formation or writing of letters.

U.S. Pat. No. 5,417,432 by Dwyer discloses a deck of playing cards wherein each card shows one letter of the alphabet. While the Dwyer cards can be used for certain games, Dwyer fails to disclose means of teaching students how to write letters or characters.

Thus, there is room in the art for new means of teaching letter or character formation that are economical, intuitive, easily transportable, and simple to use.

### BRIEF SUMMARY OF THE INVENTION

The present invention overcomes shortfalls in the related art by using a consistent and intuitive color order to teach proper letter formation. Each character (letter, upper or lower case, number or symbol) is printed in outline form. Various parts of the outline are coded with color or symbols. Arrows with various trailing lines may also be printed within the letter outlines. Each change in color signifies a lifting of the writing implement. The direction of writing is shown by arrows, and changes in direction may be shown by lines connected to the arrows. Where strokes intersect within a character, different markings are used to show the area of overlap or intersection.

In a flash card embodiment, flash cards may be used as a visual reference to teach proper character formation. In an alternative flash card embodiment, a student may look at an incomplete rendition of a character, ascertain the missing element(s), and check the back of the card for the correct answers.

In the writing sheet embodiment, each part of a character is illustrated in a color corresponding to the order of movement. To assist in teaching the proper direction of a writing movement, arrows are used. In some instances, such as the number “9”, a line may be attached to an arrow to clarify changes in direction that do not require a lifting of the writing instrument. In noncolor embodiments, symbols may be used to replace the use of color. The writing sheet may be given to the student to use as a reference, or the sheet may be traced or colored-in by the student.

In the color-in sheet embodiment, the color may be omitted from the drawing sheets, allowing the student to recall the correct color and order when drawing-in or coloring-in the outlined characters. The color information may also be replaced with a number or other symbol to signify the required color. An instructor may check the student's finished work product for use of the proper color.

For beginning students, the outlines of the characters may be wide, so as to encourage coloring or coloring-in the characters. For more advanced students, the characters may be composed of thinner outlines, to encourage more advanced writing stroke movements.

In the computer program embodiment, a mouse or a stylus on a pressure sensitive screen may be used to trace outlined characters. As the character is correctly traced, various rewarding sights and sounds may be displayed. For example, the correct color may cascade down as a student correctly writes a character. Conversely, if a student starts at an incorrect point, the screen may refuse to respond or give some other indication of needed correction.

For advanced students, color is on the screen and is used as a tracing guide, or the entire character is used as a reference.

These and other objects and advantages will be made apparent when considering the following detailed specification when taken in conjunction with the drawings and other parts of the application. Alternative configurations and implementations of the invention are contemplated. For example, the scope of the invention contemplates the uses of numerous colors to show where a writing implement needs to be lifted. The invention may be implemented in color print media, black and white print media using numbers or characters to represent color, in flash cards, in computer programs, or in web based interactions.

### BRIEF DESCRIPTION OF THE DRAWINGS

FIG. 1 is an example of the “A” letter taught in accordance with the invention.

FIG. 2 is an example of the Hindi “K” character taught in accordance with the invention.

FIG. 3 is an example of the number “9” taught in accordance with the invention.

FIG. 4 is an example of the Spanish letter “Ñ” taught in accordance with the invention.

FIG. 5 is an example of the Chinese character for the word “light” taught in accordance with the invention.

FIG. 6 shows examples upper and lower case letters A-M taught in accordance with the invention.

FIG. 7 shows examples of upper and lower case letters N-Z taught in accordance with the invention.

### DETAILED DESCRIPTION OF THE INVENTION

Definition List 1

| Term | Definition |
|---|---|
| Character | A capital or small case letter, a number, |
| | symbol, a foreign language marking, or |
| | any other marking used for |
| | communication. |
| 1 | Green |
| 2 | Yellow |
| 3 | Red |
| 4 | Blue |
| 5 | Purple |
| 6 | Orange |
| Arrow | A starting point and direction of travel |
| | for creating a character. |
| Lines attached to | A trail to follow creating a character. |
| Arrows | |

[Reserved]

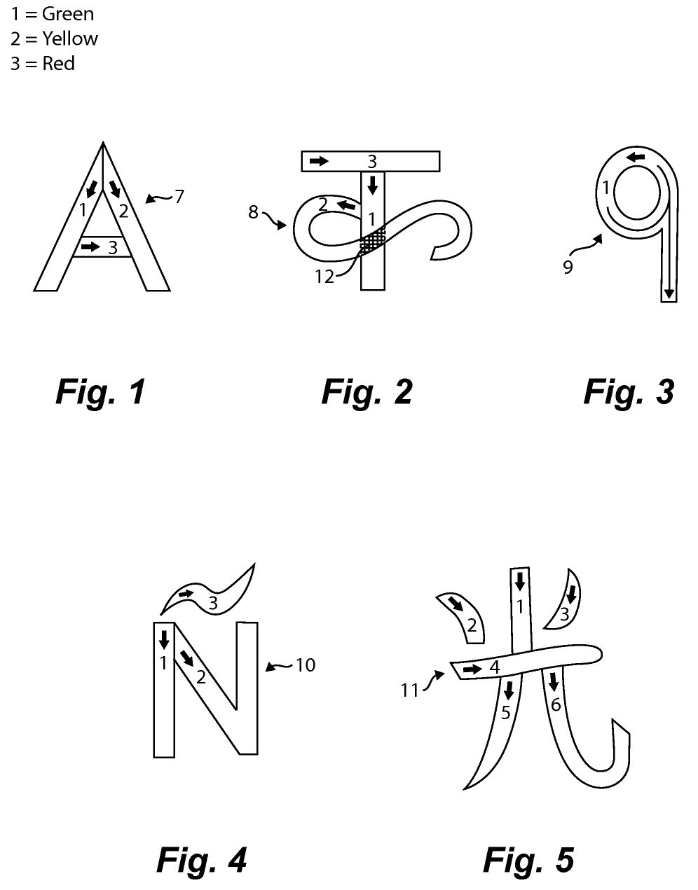

FIG. 1 shows a capital “A” where 1 represents the use of the color green and a downward arrow on the left hand side of the letter shows a downward stroke. A change in color shows that the writing implement is to be lifted from the paper.

Thus, after completing the first stroke, in area 1 or the green area, the writing implement is lifted and placed upon the arrow in area 2, which is on the right hand side of the letter “A” shown in FIG. 1. Area 2 is a yellow area. The downward arrow within area 2 shows that the stroke is to be downward. After observing, drawing, marking, or coloring in area 2, the student is to address or observe area 3 next. Area 3 is in red and contains a horizontal arrow to depict a marking movement from left to right.

The invention contemplates more than upper and lower case English letters and is well suited for characters of other languages. For example, FIG. 2 shows the application of the invention to the 8 Hindi “K”. Section 12 in FIG. 2 illustrates an area where area 1 and 2 or a green and yellow area intersect. The area of intersection 12 may be marked in such a way so as to avoid confusion to the student.

FIG. 3 shows the invention applied to the number “9”. The character is taught with one stroke, and hence the interior of the outline is green or marked herein as 1. The arrow at the top of the “9” provides a starting point and starting direction. The line attached to the lower arrow and traveling though part of the upper circle and lower line segment further teaches the correct formation of the character.

FIG. 4 shows the invention applied to 10 the letter Spanish Ñ. The change in color from 2 to 3 or yellow to red is especially useful in creating the top enyea as a separate stroke is required.

FIG. 5 shows the application of the invention to the Chinese symbol or character for 11 “light”. As more than three strokes are required, the colors 4, 5 and 6 or blue, purple, and orange are introduced.

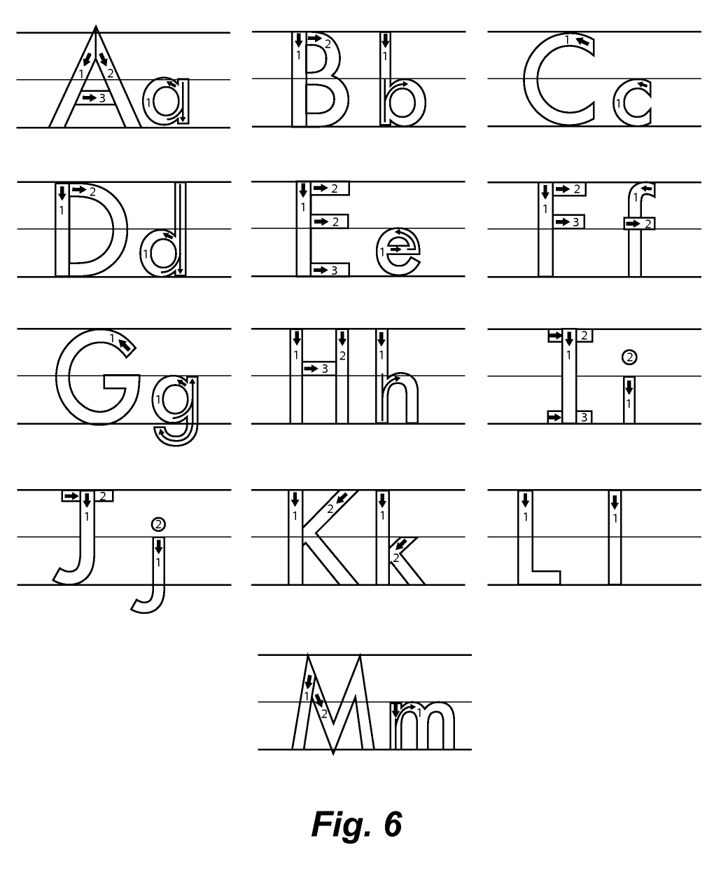

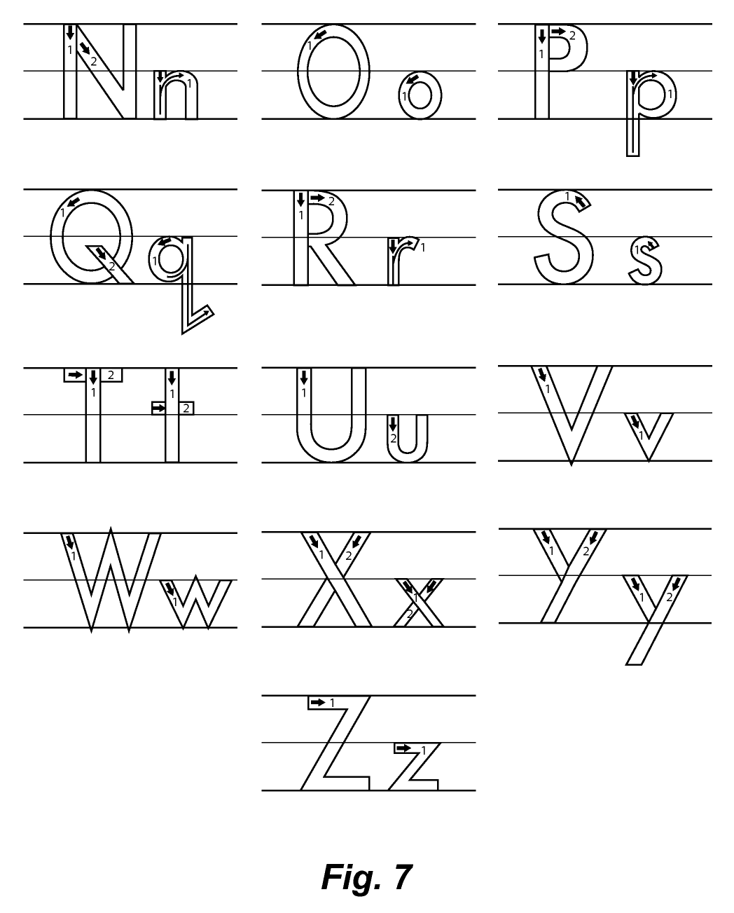

FIG. 6 shows the application of the invention to letters A to N in both upper and lower case. FIG. 7 shows the application of the invention to the letters M to Z in both upper and lower case.

### The Preferred Embodiment

FIGS. 1 to 6 show the preferred embodiment and the preferred color configuration. In the preferred embodiment, the characters are printed in color and presented to a student as a learning reference. The student looks at the printed reference, and then mimics the order, direction and pencil lifts shown by the printed reference. The reference is thus reusable, portable, and inexpensive. The reference may be left with the student or retrieved by the instructor.

### Tracing Embodiment

Some students are unable to draw straight lines or may have limited memory or attention spans. Some students may also have diminished fine motor skills. To teach a familiarity with letters, a tracing embodiment of the invention allows students to draw or color-in the outlines of the characters. In the tracing embodiment, color may be used or numbers may be used to show the order of creation and where the writing implement is lifted. The use of numbers, such as shown in the Figures herein, facilitates teaching where only black and white printing is available or practical. For color or black and white embodiments, arrows and lines may be used within the character outlines to show starting points and all required writing movements.

### Flash Card Embodiment

Similar to the preferred embodiment, a character drawn in accordance with the invention, may be printed in color upon a flash card. A student my view a collection of flash cards to reinforce the proper formation of writing characters.

Alternatively, one side of a flash card may contain a question about formation of a character, while the other side of the flash card contains the answer. Another question and answer embodiment contemplates the partial formation of a character on one side, and the missing formation on the other side.

Computer Program

For students who enjoy the use of computers, PDA's, handheld game players, console game players, touch screens, or Internet interaction, the invention may be implemented in an electronic form, such as a computer program or Internet based application.

A screen may start out with the outline of a character. The student may use a touch screen, manipulate a mouse pointing device, stylus or use other means to trace or otherwise draw a character. If the student's movement is correct, the area marked by the student may be shown to cascade with the correct color. If a student should start in the wrong location of a character, or mark in an incorrect direction, the screen may stay blank, until a correction is made.

What is claimed is:

1. A method of teaching the formation of characters comprising the use of:
a) an outline of a character;
b) different colors applied within the boundaries of the outlined character to note the need to lift a writing implement in writing the character and to indicate the proper sequencing in writing the components of the character; and
c) arrows to convey the proper starting points and direction used in writing the character.

2. The method of claim 1 comprising the use of lines attached to the arrows to demonstrate the path of travel needed in writing the outlined character.

3. The method of claim 2 used as a reference guide.

4. The method of claim 2 used as a flash card.

5. The method of claim 4 comprising the use of an incomplete character outline on one side of the flash card and the use of the missing character outline on the other side of the flash card.

6. The method of claim 2 used as means to allow a student to fill in the outline of the character.

7. The method of claim 6 comprising a drawing sheet used to allow a student to fill in the outline of a character.

8. The method of claim 7 comprising the use of symbols to replace the use of color.

9. The method of claim 6 comprising the use of a computer program used to allow a student to fill in a character.

10. The method of claim 9 wherein the computer program displays color within the outline of the character as the student correctly fills in the outline of the character.

11. The method of claim 10 wherein the computer program does not change the display of the outlined character when the student is incorrectly filling in the outline.

12. A reference guide used to teach the proper formation of characters comprising:
a) an outline of a character;
b) different colors applied within the boundaries of the outlined character to note the need to lift a writing implement in writing the character and to indicate the proper sequencing in writing the components of the character; and
c) arrows to convey the proper starting points and direction used in writing the character.

13. The reference guide of claim 12 comprising lines attached to the arrows to demonstrate the path of travel needed in writing the outlined character.

14. The reference guide of claim 13 used to fill in the outlined character.

15. The reference guide of claim 14 wherein symbols are used to replace the use of color.

16. The reference guide of claim 13 comprising the use of a sheet of paper.

17. The reference guide of claim 13 comprising the use of a flash card.

18. The reference guide of claim 13 comprising the use of a computer program.

19. The reference guide of claim 12 wherein intersections within the characters are marked differently than the rest of the character.

20. The reference guide of claim 12 where the color green is used to show the first component of a character, yellow is used to show the second component of a character, and red is used to show the third component of a character.
